(19) United States
(12) Patent Application Publication
(10) Pub. No.: US 2008/0297778 A1
(43) Pub. Date: Dec. 4, 2008

(54) OPTICAL AXIS ADJUSTING DEVICE AND OPTICAL AXIS ADJUSTING METHOD USING THE SAME

(75) Inventors: Yuichi Takei, Nagano (JP); Tadashi Takeda, Nagano (JP); Katsuyoshi Miyasaka, Nagano (JP)

Correspondence Address: CANTOR COLBURN, LLP, 20 Church Street, 22nd Floor, Hartford, CT, 06103, US

(73) Assignee: NIDEC SANKYO CORPORATION, Nagano (JP)

(21) Appl. No.: 12/127,346

(22) Filed: May 27, 2008

(30) Foreign Application Priority Data
May 28, 2007 (JP) 2007-140872
May 28, 2007 (JP) 2007-140873

(51) Int. Cl. G01B 11/26

(52) U.S. Cl. 356/141.2

(57) ABSTRACT

An optical axis adjusting device for adjusting an optical axis in an optical head device may include a rotatable part which is turnably mounted on a main base so that the optical head device is capable of being turned with an axis X which is set to be at a spot position of one of the return light beams of the two laser beams. The optical axis adjusting device may include a correcting means for converting an optical axis shift on the light receiving face when the other laser beam is emitted to a non-corresponding optical medium, into an optical axis shift on the light receiving face when the other laser beam is emitted to the other corresponding optical medium.

### CROSS REFERENCE TO RELATED APPLICATION

The present invention claims priority under 35 U.S.C. §119 to Japanese Application No. 2007-140872 filed May 28, 2007 and Japanese Application No. 2007-140873 filed May 28, 2007, both of which are incorporated herein by reference.

### FIELD OF THE INVENTION

At least an embodiment of the present invention may relate to an optical axis adjusting device and an optical axis adjusting method with the use of the optical axis adjusting device. More specifically, at least an embodiment of the present invention may relate to an optical axis adjusting device for an optical head device for recording into and/or reproducing from an optical recording medium such as a CD (Compact Disc) or a DVD (Digital Versatile Disc), and may relate to an optical axis adjusting method with the use of the optical axis adjusting device.

### BACKGROUND OF THE INVENTION

Optical head devices have been conventionally known which perform reproduction from or recording into an optical recording medium such as a CD or a DVD. The optical head device is structured so that a laser beam emitted from a light source is irradiated on an optical recording medium through an optical system and a return light beam is received with a light receiving element

In an optical head device which is compatible with a CD and a DVD, wavelengths of laser beams for CD and DVD are different from each other and thus the light receiving face of the light receiving element is formed with a light-receiving part for CD and a light-receiving part for DVD for receiving two kinds of return light beams. Therefore, in order to accurately receive a light amount of a return light beam, a so-called optical axis adjustment is performed in assembling steps for an optical head device so that spot positions of the return light beams coincide with the respective light-receiving parts (see, for example, Japanese Patent Laid-Open No. 2006-302415).

For example, in an optical head device on which two kinds of independent light sources for CD and DVD are respectively mounted, the optical axis adjustments are performed so that optical axes of the laser beams for CD and DVD are respectively adjusted by using an optical axis adjusting device for CD and an optical axis adjusting device for DVD. In other words, as shown in FIG. 15(a), the optical axes are adjusted in an X-axis direction and a Y-axis direction (two dimensions) with respect to the respective laser beams so that the return light beam SPa of a laser beam for CD is aligned with the light-receiving part 100a for CD in the light receiving face 100 and the return light beam SPb of a laser beam for DVD is aligned with the light-receiving part 100b for DVD.

However, recently, in the optical head device as described above, in order to reduce number of parts and to obtain easy assembly, a two-wavelength laser light source having two kinds of light emitting areas is often used in which light emitting elements for CD and DVD are integrated into one package. When the two-wavelength laser light source is used, optical axes of the laser beams for CD and DVD cannot be adjusted separately.

Therefore, as shown in FIG. 15(b), when a shift amount from a light-receiving part 100a for CD of a return light beam SPa of a laser beam for CD is different from a shift amount from a light-receiving part 100b for DVD of a return light beam SPb of a laser beam for DVD, adjustment in a rotating direction is required as well as adjustments in the “X”-axis direction and the “Y-axis direction. As a result, much time is required for adjustment of the optical axes and thus, a manufacturing cost increases and, in addition, spot positions of the respective return light beams of the laser beams for CD and DVD and their corresponding light-receiving parts cannot be accurately coincided with each other and thus reliability of the optical head device decreases.

Further, as described in the above-mentioned optical head device, in order to perform optical axis adjustment in an optical head device which includes two light sources for emitting laser beams for CD and DVD and a piece of light receiving element having two light-receiving parts for receiving return light beams from disks corresponding to the light sources, two optical axis adjusting devices, which are an optical axis adjusting device for CD and an optical axis adjusting device for DVD, are commonly used.

Specifically, optical axis adjustments are performed as follows. First, an optical head device is mounted on an optical axis adjusting device for CD and optical axis adjustment of a laser beam for CD is performed. After that, the optical head device is detached and placed on an optical axis adjusting device for DVD to perform optical axis adjustment of a laser beam for DVD. After that, the optical head device is detached and placed on the optical axis adjusting device for CD again and it is confirmed whether an optical axis shift of the laser beam for CD occurs or not.

However, the optical axis adjustment described above which uses the optical axis adjusting devices for CD and DVD is provided with the following problems.

In other words, in the above-mentioned optical axis adjustment, two optical axis adjusting devices are required for one optical head device and the optical head device is required to be detached from one optical axis adjusting device and placed on the other optical axis adjusting device and thus assembling work for the optical head device becomes complicated.

Further, the optical axis of the laser beam which has been already adjusted may be shifted again due to a mounting error when the optical head device is replaced on the other optical axis adjusting device from one of the optical axis adjusting devices.

### SUMMARY OF THE INVENTION

In view of the problems described above, at least an embodiment of the present invention may advantageously provide an optical axis adjusting device in which two optical axes of two kinds of laser beams emitted from a two-wavelength laser light source in an optical head device can be easily and accurately adjusted and an optical axis adjusting method with the use of the optical axis adjusting device.

Further, at least another embodiment of the present invention may advantageously provide an optical axis adjusting device for an optical head device provided with a single light receiving element for receiving respective return light beams from optical recording media, in which two optical axes of two kinds of laser beams whose wavelengths are different from each other can be adjusted with a single optical axis adjusting device.

Thus, according to at least an embodiment of the present invention, there may be provided an optical axis adjusting device for adjusting an optical axis in an optical head device. The optical head device includes a two-wavelength laser light source which is capable of emitting two laser beams with two different wavelengths from each other, a light receiving element which is provided with a light receiving face that is formed with two light-receiving parts for respectively receiving return light beams from optical recording media of the light beams emitted from the two-wavelength laser light source, and an optical system which forms an optical path for the emitted light beams and the return light beams. The optical axis adjusting device includes a rotatable part which is capable of turning one of the two-wavelength laser light source, the light receiving element and an optical element structuring the optical system to turn a spot position of the return light beam on the light receiving face.

According to the optical axis adjusting device structured as described above in accordance with at least an embodiment of the present invention, one of the two-wavelength laser light source, the light receiving element and an optical element structuring the optical system can be turned to rotatably move the spot position of the return light beam on the light receiving face. Therefore, even when the optical head device to which optical axis adjustment is to be applied is mounted with the two-wavelength laser light source, the optical axes of two kinds of laser beams are easily and rapidly adjusted and the two kinds of return laser beams can be accurately coincided with the corresponding light receiving parts of the light receiving element and thus quality of the optical head device can be improved.

In this case, the rotatable part may be structured so that one of a frame structuring the optical head device to which the two-wavelength laser light source is fixed and the light receiving element is rotatably turned. According to the structure as described above, the optical axes in the optical head device can be rapidly adjusted and the structure for optical axis adjustment can be simplified. Specifically, the rotatable part is turnably mounted on a main base so that the optical head device to which the two-wavelength laser light source and the optical element structuring the optical system are fixed is capable of being turned, and an axis X which is a turning center of the rotatable part is set to be at the spot position of one of the return light beams of the two laser beams. Further, the main base may be mounted with a mounting position adjustment part for adjusting a mounting position of the light receiving element in the optical head device.

In accordance with at least an embodiment of the present invention, the optical axis adjusting device includes one of two kinds of optical media which are respectively to be reproduced by the laser beams with two different wavelengths, and a correcting means for converting an optical axis shift on the light receiving face when another laser beam which is different from one of the laser beams for reproducing the one of the two kinds of optical media is emitted to the one of the optical media, into an optical axis shift on the light receiving face when the other laser beam is emitted to the other of two kinds of optical media According to this embodiment, the optical axes of the laser beams with two different wavelengths can be adjusted by a single optical axis adjusting device which is mounted with only the one of two lands of optical media. Therefore, the optical head device is not required to replace from an optical axis adjusting device to another optical axis adjusting device like a case where two optical axis adjusting devices are used and thus the optical axis adjustment can be rapidly performed.

Further, according to at least another embodiment of the present invention, there may be provided an optical axis adjusting device for adjusting an optical axis in an optical head device. The optical head device includes two light sources which are capable of emitting respective laser beams with different wavelengths from each other, a light receiving element which is provided with a light receiving face that is formed with two light-receiving parts for respectively receiving return light beams from an optical recording medium of the light beams emitted from the light sources, and an optical system which forms an optical path for the emitted light beams and the return light beams. The optical axis adjusting device includes one of two kinds of optical media which are respectively to be reproduced by the laser beams with two different wavelengths, and a correcting means for converting an optical axis shift on the light receiving face when an other laser beam which is different from a laser beam for reproducing the one of the optical media is emitted to the one of the optical media, into an optical axis shift on the light receiving face when the other laser beam is emitted to the other of the optical media.

According to the optical axis adjusting device structured as described above in accordance with at least an embodiment of the present invention, the other of the two kinds of optical media which are respectively reproduced by the laser beams with two different wavelengths is not mounted on the optical axis adjusting device. However, the optical axis adjusting device is provided with a correcting means for converting an optical axis shift on the light receiving face when the other laser beam which is different from a laser beam for reproducing the one of the optical media is emitted to the one of the optical media, into an optical axis shift on the light receiving face when the other laser beam is emitted to the other of the optical media. Therefore, optical axis adjustments for two kinds of laser light sources can be performed with a single optical axis adjusting device on which the one of the optical media is mounted.

In accordance with at least an embodiment of the present invention, the correcting means includes a memory table which stores correction data on a basis of difference between the optical axis shift on the light receiving face when the other laser beam is emitted to the one of two kinds of optical media and the optical axis shift on the light receiving face when the other laser beam is emitted to the other of two kinds of optical media. According to the structure as described above, an optical axis shift in the non-corresponding state of a laser beam to an optical recording medium can be easily converted into an optical axis shift when the laser beam is irradiated on the corresponding optical recording medium. Specifically, the correcting means may include correlation data between an optical axis shift of a return light beam on the light receiving face when the other laser beam is irradiated on a pseudo disk for optical axis adjustment corresponding to the one of the laser beams and an optical axis shift of a return light beam on the light receiving face when the other laser beam is irradiated on a pseudo disk for optical axis adjustment corresponding to the other laser beam, and a position of the other laser beam on the light receiving face is adjusted on a basis of the optical axis shift which is obtained by irradiating the other laser beam on the pseudo disk for optical axis adjustment corresponding to the one of the laser beams.

Further, in accordance with at least an embodiment of the present invention, the correcting means includes a monitor which is capable of taking a position of the return light beam on the light receiving face, and a target position setting means for displaying a target position of an optical axis of the other laser beam on the light receiving face on the monitor on a basis of correlation between the optical axis shift on the light receiving face when the other laser beam is emitted to the one of two kinds of optical media and the optical axis shift on the light receiving face when the other laser beam is emitted to the other of two kinds of optical media. According to the structure as described above, an optical axis shift in the non-corresponding state of a laser beam to an optical recording medium can be rapidly converted into an optical axis shift when the laser beam is irradiated on the corresponding optical recording medium.

Further, in accordance with at least an embodiment of the present invention, two kinds of optical media are a CD and a DVD. In this case, optical axis adjustments in the optical head device for reproduction or recording for a CD and a DVD can be rapidly and accurately performed.

Further, according to at least another embodiment of the present invention, there may be provided an optical axis adjusting method in an optical axis adjusting device for adjusting optical axes in an optical head device. The optical axis adjusting method includes a first adjusting step in which a spot position of one of the return light beams is adjusted so as to coincide with a light-receiving part corresponding to the one of the return light beams, and a second adjusting step in which the rotatable part is turned with an optical axis of the return light beam which has been adjusted in the first adjusting step as a turning center so that a spot position of the other of the return light beams is adjusted so as to coincide with a light-receiving part corresponding to the other of the return light beams. According to the optical axis adjusting method with the use of the optical axis adjusting device, the spot position of one of the return light beams is coincided with the corresponding light receiving part of the light receiving element and then a spot position of the other return light beam is rotatably turned with the coincided optical axis as the rotating center. According to the optical axis adjusting method as described above, the optical axes can be adjusted easily and a manufacturing cost of the optical head device can be reduced largely.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

Embodiments will now be described, by way of example only, with reference to the accompanying drawings which are meant to be exemplary, not limiting, and wherein lice elements are numbered alike in several Figures, in which:

FIG. 1 is a schematic perspective view for explaining a structure of an optical axis adjusting device in accordance with at least an embodiment of the present invention.

FIG. 2 is a schematic perspective structure view showing an optical system in an optical head device.

FIG. 3 is a perspective outward appearance view showing the optical head device.

FIG. 4 is a perspective outward appearance view showing a light receiving element which is mounted on the optical head device.

FIG. 5 is a flow chart for explaining an optical axis adjusting method for an optical head device which is used in the optical axis adjusting device shown in FIG. 1 in accordance with a first embodiment.

FIG. 6 is a plan view for explaining a first adjusting step, i.e., a first optical axis adjustment step for a laser beam for a CD or a DVD.

FIGS. 7(a) and 7(b) are plan views for explaining a second adjusting step, i.e., a second optical axis adjustment step for a laser beam for a DVD or a CD.

FIG. 8 is a flow chart for explaining an optical axis adjusting method for an optical head device which is used in the optical axis adjusting device shown in FIG. 1 in accordance with a second embodiment.

FIGS. 9(a) and 9(b) are graphs showing a correlation between a shift amount of an optical axis on a light receiving face when a laser beam for DVD is emitted to a pseudo disk for CD and a shift amount of an optical axis on the light receiving face when the laser beam for DVD is emitted to a pseudo disk for DVD in an optical head device.

FIG. 10 is a schematic view for explaining a definition of a shift amount of an optical axis of a return light beam on a light receiving face of a light receiving element.

FIG. 11(a) is a plan view showing a case where a shift amount of an optical axis of a return light beam is “Px=0” and “Py=100”, and FIG. 11(b) is a plan view showing a case where a shift amount of the optical axis of the return light beam is “Px=−100” and “Py=0”.

FIG. 12 is a plan view showing a light receiving element in an optical head device in which a so-called “three-beam method” is adopted and which is viewed from a light receiving face side.

FIG. 13 is a schematic structure view showing another optical system in an optical head device in accordance with at least another embodiment of the present invention.

FIG. 14 is a perspective outward appearance view showing the optical head device which is shown in FIG. 13.

FIG. 15(a) is a schematic view showing a light receiving face in a light receiving element on which optical axis adjustments for respective laser beams for CD and DVD are performed, and FIG. 15(b) is a schematic view showing the light receiving face in the light receiving element where a shift amount of a return light beam of a laser beam for CD from a light-receiving part for CD and a shift amount of a return light beam of a laser beam for DVD from a light-receiving part for DVD are different from each other.

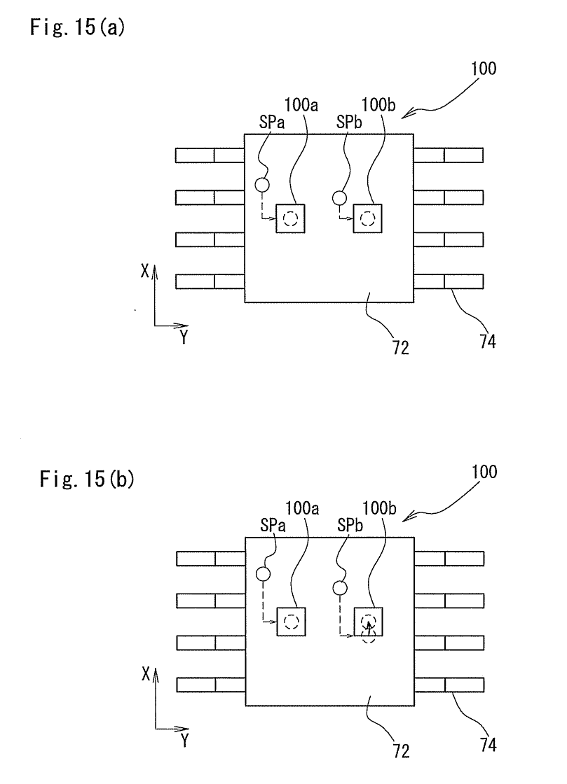

### DETAILED DESCRIPTION OF THE PREFERRED EMBODIMENTS

Embodiments of the present invention will be described in detail below with reference to the accompanying drawings.

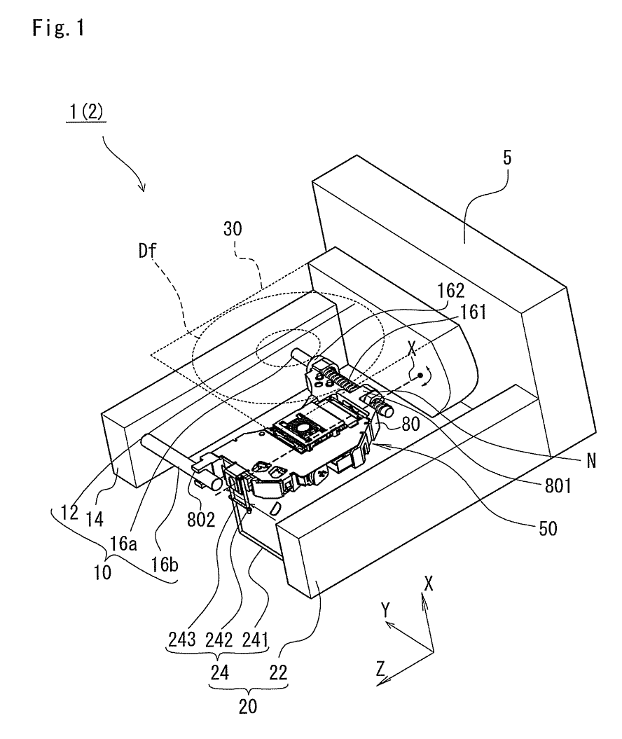

FIG. 1 is a schematic perspective view for explaining a structure of an optical axis adjusting device 1 in accordance with at least a first embodiment of the present invention. The optical axis adjusting device 1 is a device for adjusting optical axes of an optical head device 50 corresponding to reproduction/recording for a CD and a DVD (a so-called CD/DVD dual writer drive).

The optical axis adjusting device 1 is structured so that a rotatable part 10 for turning the optical head device 50 and a mounting position adjustment part 20 for adjusting a mounting position of a light receiving element of the optical head device 50 are attached to a main base 5.

The rotatable part 10 includes a rotatable base 12 which is turnably mounted on the main base 5, a support shaft 14 stood on the rotatable base 12, frame mounting shafts 16a and 16b which are protruded from a side face of the support shaft 14 and serve as a reference for a mounting position of the optical head device 50, and a disk mounting part 30. The rotatable base 12 is mounted on the main base 5 so as to be turned around an axis X by a drive source such as a motor not shown. A screw part 161 and a stopper part 162 are formed on the frame mounting shaft 16a which is protruded from the support shaft 14. The disk mounting part 30 which is fixed to the rotatable base 12 is a member on which a disk Df for performing an optical axis adjustment is mounted. In the optical axis adjusting device 1, a pseudo-disk for CD and a pseudo-disk for DVD are used instead of a CD and a DVD which are actually used. This is because that an actual disk is too large in diameter to adjust an optical axis in the optical axis adjusting device 1. Therefore, the pseudo-disk is formed in the smallest size which is capable of reflecting an outputted light.

In this embodiment, the structure of an optical axis adjusting device for CD described below and the structure of an optical axis adjusting device for DVD are the same except the disk Df which is used for optical axis adjustment.

The mounting position adjustment part 20 is structured so that a light receiving element holding part 24 is attached to the support shaft 22. The light receiving element holding part 24 is structured so that a main shaft 241 is bent at a right angle and a holding member 242 is attached near a tip end portion of the main shaft 241. The holding member 242 is connected with the main shaft 241 through a screw member 243 and a width D between the main shaft 241 and the holding member 242 can be adjusted by rotating the screw member 243. Further, the light receiving element holding part 24 is attached to the support shaft 22 so as to be movable in the X-axis and Y-axis directions.

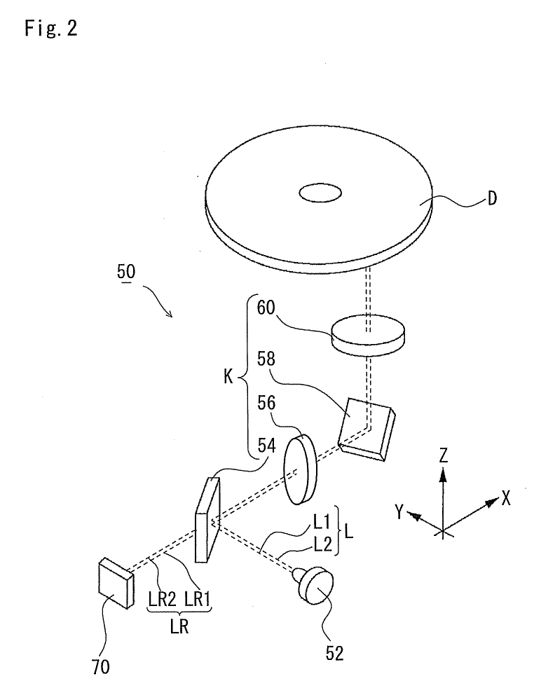

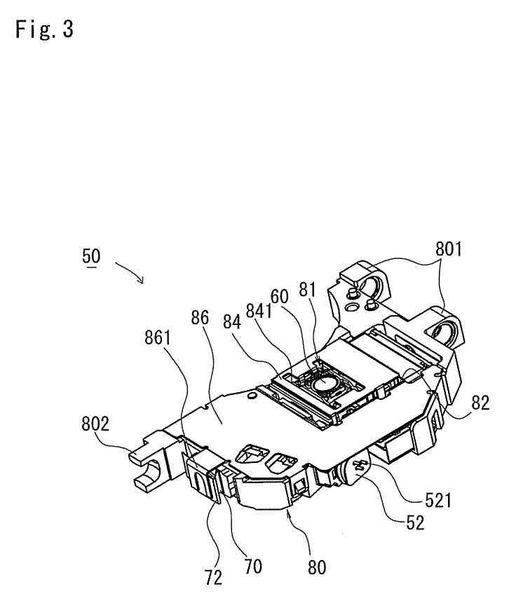

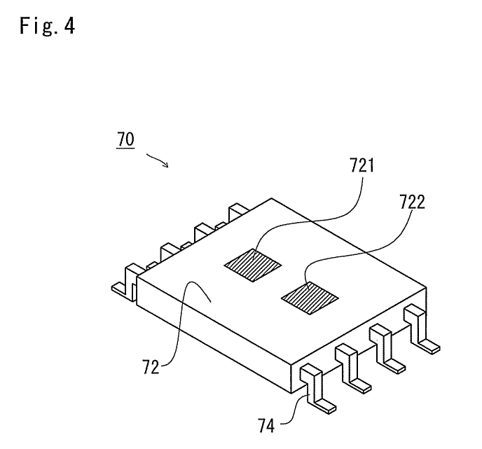

Next, the optical head device 50 whose optical axis is adjusted by the optical axis adjusting device 1 structured as described above will be described below with reference to FIGS. 2 and 3. FIG. 2 is a schematic perspective structure view showing an optical system in the optical head device 50 and FIG. 3 is a perspective outward appearance view showing the optical head device 50. Further, FIG. 4 is a perspective outward appearance view showing a light receiving element 70 which is mounted on the optical head device 50.

As shown in FIG. 2, the optical head device 50 includes a two-wavelength laser light source 52 as a light source, an optical system K which structures a forward path for converging an emitted light beam L (an emitted light beam for CD is L1 and an emitted light beam for DVD is L2) emitted from the two-wavelength laser light source 52 on an optical recording disk D through an objective lens 60 and a return path for directing a return light beam LR (a return light beam from CD is LR1 and a return light beam from DVD is LR2) reflected by the optical recording disk D to a light receiving element 70, and the light receiving element 70 for signal detection which receives the return light beam LR. These structural components are fixed to a frame 80 to structure the optical head device 50.

The two-wavelength laser light source 52 as a light source is structured so that two semiconductor laser elements having different light emitting regions are integrated on a single chip. Either an emitted light beam L1 with a red light area (bandwidth of about 650 nm) corresponding to a CD or an emitted light beam L2 with a near infrared light area (bandwidth of about 780 nm) corresponding to a DVD is selected by a control device not shown and emitted from the two-wavelength laser light source 52.

The optical system K includes, when coordinate axes perpendicular to each other are set to be X-axis, Y-axis and Z-axis (as shown by the arrows X, Y and Z in FIG. 1), a half mirror 54 as an optical path splitting element which reflects the emitted light beam L emitted from the two-wavelength laser light source 52 in the Y-axis direction to the X-axis direction, a collimating lens 56 for converting the emitted light beam L from the half mirror 54 into a parallel light, a total reflection mirror 58 for reflecting the parallel light to the Z-axis direction, an objective lens 60 for converging the parallel light on a recording face of an optical recording disk D and the like. After the emitted light beam L is reflected by the recording face of the optical recording disk D, the emitted light beam L returns the optical path in a reverse direction as a return light beam LR to be transmitted through the half mirror 54 and received by the light receiving element 70.

The light receiving element 70 is an element for calculating light receiving amounts of the return light beam LR in order to obtain a sound or video signal and other signals for a CD or a DVD. As shown in FIG. 4, the light receiving face 72 for receiving the return light beam LR is formed with a light receiving part 721 for CD for receiving the return light beam LR1 from a CD and a light receiving part 722 for DVD for receiving the return light beam LR2 from a DVD. Further, terminal parts 74 for obtaining electric conduction are formed so as to protrude from side faces of the light receiving element 70. In this embodiment, the light receiving part 721 for CD and the light receiving part 722 for DVD are formed so that their distance is equal to a distance between the laser beam for CD and the laser beam for DVD which are emitted from the two-wavelength laser light source 52.

As shown in FIG. 3, the two-wavelength laser light source 52, the optical elements structuring the optical system K, and the light receiving element 70 are fixed on the frame 80 which is an integrally molded resin product. The frame 80 is formed with a first bearing part 801 and a second bearing part 802 through which guide shafts of a drive device for driving an optical recording disk D not shown are penetrated.

The two-wavelength laser light source 52 is fixed to a side face of the frame 80 so that connection terminal parts 521 are directed to the outside. The objective lens 60 is fixed to a lens drive part 81 which is disposed in a frame-formed opening part 82 at a roughly center portion of the frame 80. Further, the total reflection mirror 58 is fixed just under the objective lens 60. A first top plate 84 which covers the lens drive part 81 is formed with an opening 841 for exposing the objective lens 60 and the emitted light beam L reaches the optical recording disk D through the opening 841.

The light receiving element 70 is mounted on a circuit board 72 for light receiving element, which is attached to the frame 80 so that the circuit board 72 for light receiving element is directed to the outside. The light receiving element 70 is finally fixed with an adhesive after its mounting position has been adjusted (after optical axis adjustment). Therefore, before its mounting position is adjusted, the light receiving element 70 is temporarily fixed by a bending piece 861 which is protruded from a second top plate 86 for covering the frame 80 so that the light receiving element 70 is pressed to the frame 80 by the bending piece 861. Further, the half mirror 54 and the collimating lens 56 are mounted on the optical axis and covered by the second top plate 86.

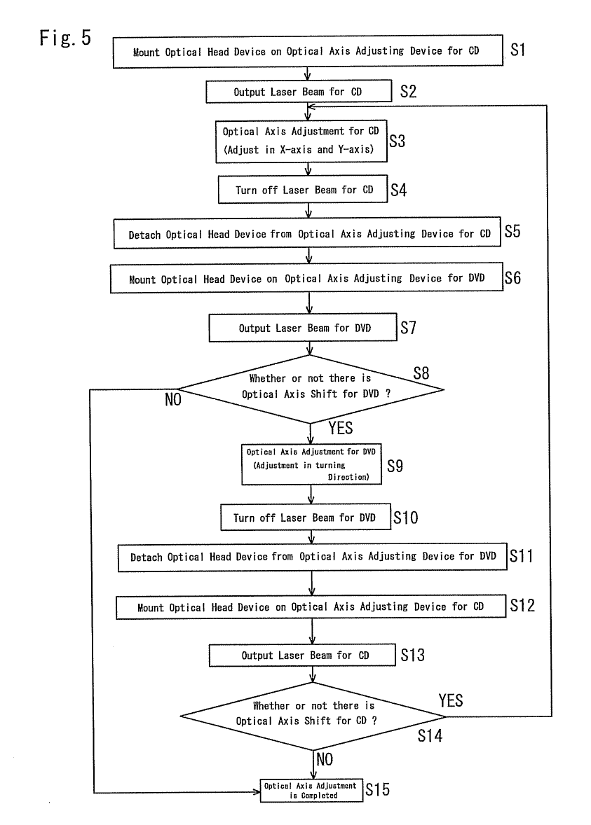

Next, an optical axis adjusting method for the optical head device 50 with the use of the optical axis adjusting device 1 will be described below with reference to the flow chart shown in FIG. 5.

First, as shown in FIG. 1, the optical head device 50 is fixed to the optical axis adjusting device for CD through the first bearing part 801 and the second bearing part 802 (step S1). Specifically, the frame mounting shafts 16a and 16b are inserted into the first bearing part 801 and the second bearing part 802 to a position where the first bearing part 801 abuts with a stopper part 162 of the frame mounting shaft 16a Then, a nut N or the lice is threadedly engaged with a screw part 161 of the frame mounting shaft 16a and thus the optical head device 50 is fixed at a predetermined position.

The light receiving element 70 is held by the light receiving element holding part 24 by adjusting the width dimension D of the main shaft 241 and the holding member 242 of the light receiving element holding part 24. In this manner, mounting of the optical head device 50 to the optical axis adjusting device for CD is completed.

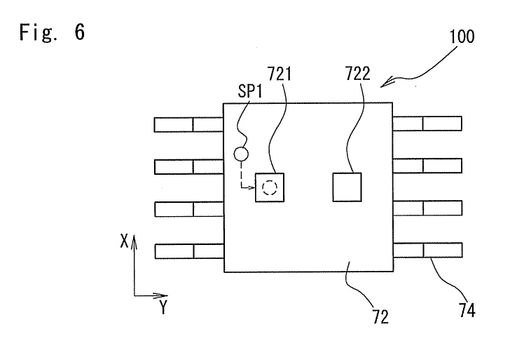

After the mounting of the optical head device 50 has been finished, a laser beam for CD is outputted from the two-wavelength laser light source 52 (step S2). Then, while reading a spot position SP1 on the light receiving face 72 of the return light beam LR1 from the pseudo disk for CD, the light receiving element 70 is moved in the X-axis direction and the Y-axis direction by driving the light receiving element holding part 24 to perform adjustment of its mounting position (optical axis adjustment) (first adjusting step). Specifically, as shown in FIG. 6, the position of the light receiving element 70 is adjusted so that the spot position SP1 of the return light beam LR1 on the light receiving face 72 of the light receiving element 70 coincides with a center of the light receiving part 721 for CD (step S3). After the adjustment of its position has been finished, the laser beam for CD is turned off (step S4).

After the adjustment of the optical axis of the return light beam LR1 has been finished, the optical head device 50 is detached from the optical axis adjusting device for CD (step S5), and then the optical head device 50 is set to an optical axis adjusting device for DVD on which a pseudo disk for DVD is mounted (step S6). Then, the laser beam for DVD is outputted from the two-wavelength laser light source 52 (step S7), and it is confirmed whether the spot position SP2 of the return light beam LR2 from the pseudo disk for DVD coincides with the light receiving part 722 for DVD or not (whether there is an optical axis shift or not) (step S8). When there is no optical axis shift of the laser beam for DVD (NO in the step S8), the optical axis adjustment is finished because there is no shift of the optical axes of the laser beams for CD and DVD (step S15). When the optical axis adjustment has been finished, the two-wavelength laser light source 52 and the light receiving element 70 are completely fixed to the frame 80 with an adhesive or the like.

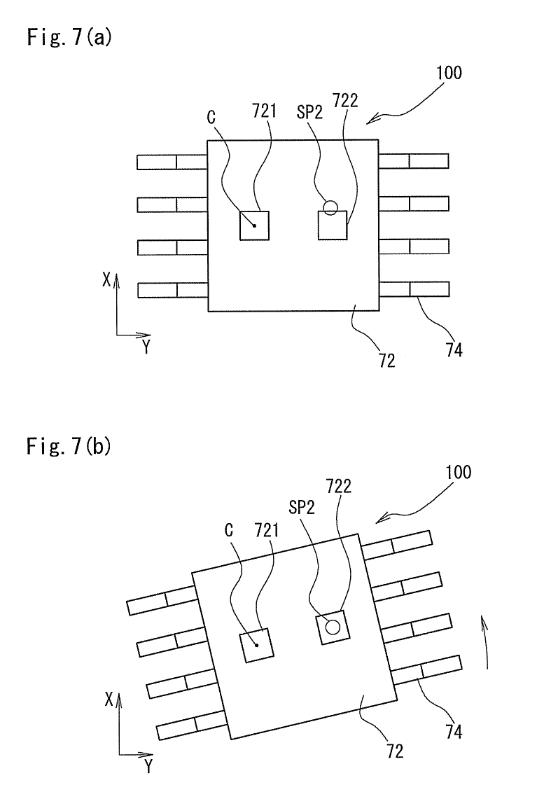

On the other hand, when the spot position SP2 of the return light beam LR2 does not coincide with the light receiving part 722 for DVD, in other words, when there is an optical axis shift of the laser beam for DVD (YES in the step S8), an optical axis adjustment of the laser beam for DVD is to be performed. In this embodiment, as described above, the two-wavelength laser light source 52 is structured so that two semiconductor laser elements having different light emitting regions are integrated on a single chip. Further, a distance between the light receiving part 721 for CD and the light receiving part 722 for DVD is set to be the same as a distance between the laser beam for CD and the laser beam for DVD which are emitted from the two-wavelength laser light source 52. Therefore, as shown in FIG. 7(a), the spot position of the return light beam LR2 is shifted from the light receiving part 722 for DVD in a rotating direction with the center point C of the light receiving part 721 for CD as a center. On the other hand, the axis X which is the center of turning of the rotatable base 12 in the optical axis adjusting device is set at the same position of the spot SP1 of the return light beam LR1 from the pseudo disk for CD. Therefore, as described above, when the spot position SP1 of the return light beam LR1 has been adjusted so as to coincide with the center of the light receiving part 721 for CD, the rotatable base 12 on the main base 5 is turned around the center point C of the light receiving part 721 for CD by turning the rotatable base 12 on the main base 5 around the axis X. Accordingly, as shown in FIG. 7(b), when the rotatable base 12 on the main base 5 is turned around the center point C of the light receiving part 721 for CD, the spot position SP2 of the return light beam LR2 is rotated and easily coincided with the light receiving part 722 for DVD (step S9) (second adjusting step).

After that, the laser beam for DVD is turned off (step S10) and then the optical head device 50 is detached from the optical axis adjusting device for DVD (step S11). After that, it is confirmed whether or not the spot position SP1 of the return light beam LR1 of the laser beam for CD is coincided with the light receiving part 721 for CD again (steps S12 through S14). In this embodiment, when the spot position SP1 of the return light beam LR1 of the laser beam for CD is coincided with the light receiving part 721 for CD (NO in the step S14), the optical axis adjustment is finished. Alternatively, when not coincided (YES in the step S14), the flow is returned to the step S3, the optical axis adjustments are performed for the laser beams for CD and DVD again.

In this embodiment, after the optical axis adjustment of the laser beam for DVD has been finished, an optical axis shift of the laser beam for CD is checked again. This is to confirm whether or not the positional shift of the light receiving element 70 or the like does not occur when the optical head device 50 is detached from the optical axis adjusting device for CD and reset to the optical axis adjusting device for DVD. In other words, the above-mentioned confirmation work is not always required and thus the optical axis adjustment of the optical head device 50 may be finished after the optical axis adjustment of the laser beam for DVD has been finished.

The above-mentioned optical axis adjusting method is that, after the optical axis adjustment of the return light beam LR1 for CD has been finished, it is confirmed whether or not the spot position SP2 of the return light beam LR2 for DVD is coincided with the light receiving part 722 for DVD. However, reversely, after the optical axis adjustment of the return light beam LR2 for DVD has been finished, it may be confirmed whether or not the spot position SP1 of the return light beam LR1 for CD is coincided with the light receiving part 721 for CD.

Next, an optical axis adjusting device 2 in accordance with at least a second embodiment of the present invention will be described below. The optical axis adjusting device 2 is different from the optical axis adjusting device 1 in accordance with the first embodiment at the point where a correction means described below is provided in the optical axis adjusting device 2. Therefore, their mechanical structures are the same as each other and thus the same notational symbols are used and their descriptions are omitted.

The optical axis adjusting device 2 is provided with a pseudo disk for CD as a disk for optical axis adjustment on the disk mounting part 30 and, in addition, provided with a correcting means including a memory table and a signal amplification means for enabling both optical axis adjustments of the laser beams for CD and DVD with a single adjusting device.

The memory table is stored with correction data based on correlation between a shift amount of the optical axis of the return light beam LR2 on the light receiving face 72 when the laser beam for DVD is irradiated on the mounted pseudo disk for CD (hereinafter, referred to as a shift amount of the optical axis in a non-corresponding state) and a shift amount of the optical axis when the laser beam for DVD is irradiated on the pseudo disk for DVD (hereinafter, referred to as a real shift amount of the optical axis). The stored correction data based on the correlation are different depending on a light source and a pseudo disk which are used and thus they are previously calculated and obtained for the optical head device 50 whose optical axes are to be adjusted.

The signal amplification means amplifies (converts) an obtained shift amount of the optical axis in the non-corresponding state into a real shift amount of the optical axis of the laser beam for DVD on the basis of the correction data based on the correlation stored in the memory table and the value is outputted as a signal.

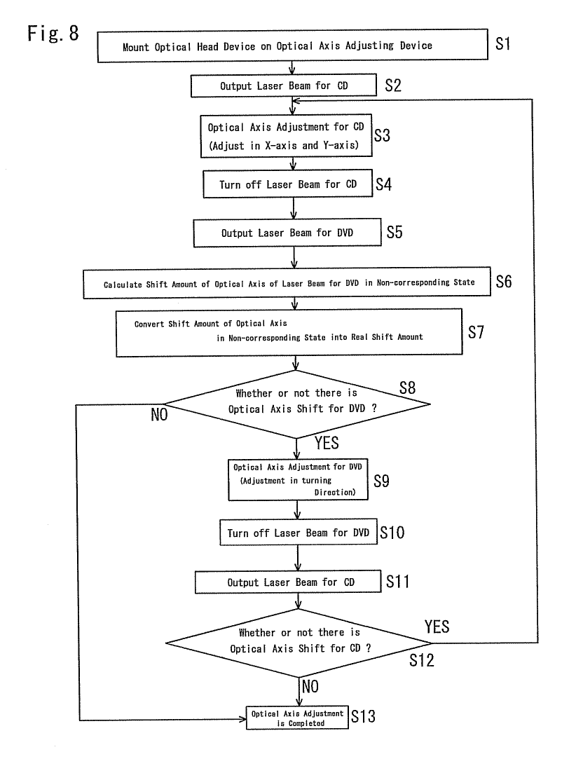

An optical axis adjusting method for the optical head device 50 which uses the optical axis adjusting device 2 as structured above will be described below with reference to the flow chart in FIG. 8.

First, similarly to the case where the optical axis adjusting device 1 is used, the optical head device 50 is mounted on the optical axis adjusting device 2 (step S1) and the optical axis adjustment for the laser beam for CD is performed (steps S2 through S4).

After that, a laser beam for DVD is outputted in the state where the pseudo disk for CD has been mounted on (step S5). As a result, a spot of the return light beam LR2 from the pseudo disk for CD is formed on the light receiving face 72. The spot position in the non-corresponding state is projected as a shift amount of the spot position of the return light beam LR2 on the light receiving face 72 on a monitor (not shown) included in the correcting means, that is, projected as a shift amount of the optical axis expressed as Px (%) and Py (%) as descnbed below. In other words, the shift amount of the optical axis of the laser beam for DVD in the non-corresponding state is calculated (step S6) by a calculation method described in detail below and projected on the monitor. The real shift amount of the optical axis is obtained (step S7) on the basis of the memory table through the shift amount of the optical axis in the obtained non-corresponding state as described above. Next, a calculation method for a shift amount of the optical axis and a method for calculating a real shift amount of the optical axis based on the memory table by using the shift amount of the optical axis in the non-corresponding state will be described below with reference to specific examples.

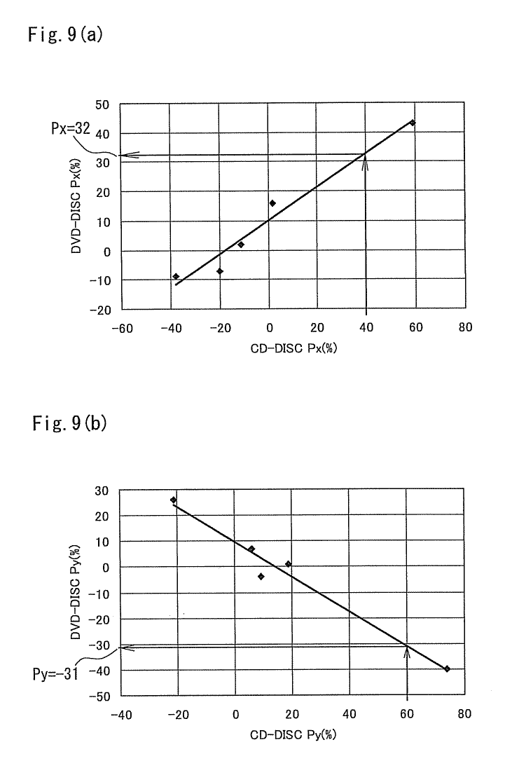

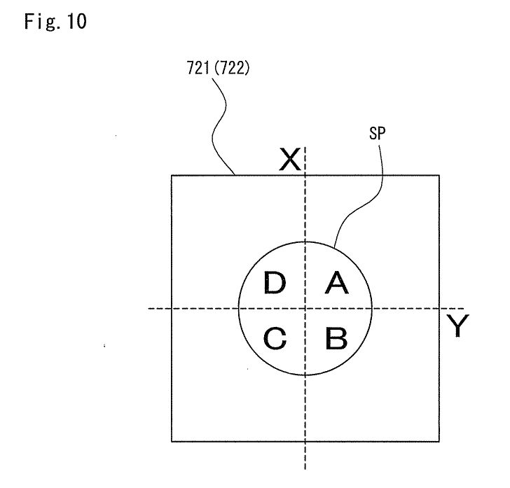

FIGS. 9(a) and 9(b) are graphs showing a correlation between a shift amount of an optical axis on the light receiving face 72 when a laser beam for DVD is emitted to a pseudo disk for CD and a shift amount of an optical axis on the light receiving face when the laser beam for DVD is emitted to a pseudo disk for DVD in an optical head device. In this embodiment, Px (%) and Py (%) in FIGS. 9(a) and 9(b) are ratios of the optical axis shifts in the X-axis direction and the Y-axis direction on the light receiving face 72. As shown in FIG. 10, the light receiving part 722 for DVD (or, light receiving part 721 for CD) is divided into four regions and an area (A through D) of the spot position SP of the return light beam is obtained. A calculation method for the shift amount of the optical axis is expressed by the following equation.

Px=(((A+D)−(B+C))/(A+B+C+D))×100 (%)

Py=(((A+B)−(C+D))/(A+B+C+D))×100 (%)

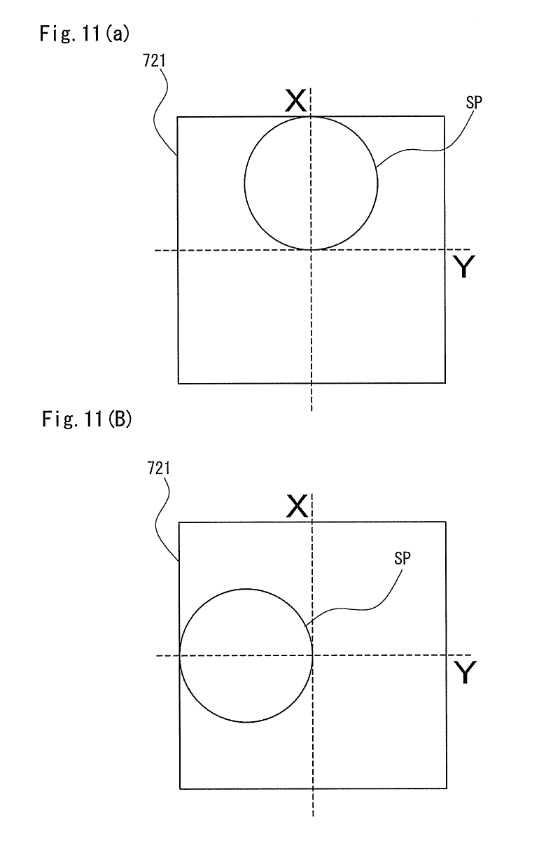

For example, in a state as shown in FIG. 11(a), the shift amount of the optical axis is expressed; Px=100(%) and Py=0(%). Alternatively, in a state as shown in FIG. 11(b), the shift amount of the optical axis is expressed; Px=0(%) and Py=−100(%). In other words, the larger the absolute value of Px is, the shift amount of the optical axis in the X-axis direction of the spot position SP of the return light beam is larger. Further, the larger the absolute value of Py is, the shift amount of the optical axis in the Y-axis direction of the spot position SP of the return light beam is larger.

In the optical axis adjustment, the real shift amount of the optical axis of the laser beam for DVD is obtained by using the correlation based on the graphs shown in FIGS. 9(a) and 9(b). For example, when the shift amount of the optical axis of the laser beam for DVD in the non-corresponding state to the pseudo disk for CD which is obtained in the step S6 is Px=40(%) and Py=60(%), the real shift amount of the optical axis is obtained as: Px=32(%) based on the graph in FIG. 9(a) and Py=−31(%) based on the graph in FIG. 9(b). In other words, the shift amount of the optical axis of the laser beam for DVD is calculated even when a pseudo disk for DVD is not used.

As described above, the optical axis adjusting device 2 is provided with the memory table in which the correction data based on the differences between the shift amounts of the optical axis in the non-corresponding state and the real shift amounts of the optical axis are stored, which are obtained on the basis of the graphs of the correlation of the shift amounts of the optical axis previously measured as shown in FIGS. 9(a) and 9(b). Therefore, the shift amounts of the optical axis in the non-corresponding state are converted into the real shift amounts of the optical axis by using the memory table in the steps S6 and S7. In this manner, the shift amount of the optical axis which is converted is displayed as a target position on a monitor by a target position setting means included in the correcting means. In this case, the target position is a position which is to be shifted or moved by the shift amount of the optical axis calculated on the basis of the position on the light receiving part 722 for DVD and the correlation graph. Therefore, the optical axis adjustment can be performed by means of that the spot position of the return light beam LR2 in the non-corresponding state is coincided with the target position displayed on the monitor by the target position setting means.

In the embodiment described above, a memory table is used as the correcting means but the memory table is not always required. In other words, differences between the shift amounts of the optical axis in the non-corresponding state and the real shift amounts of the optical axis are calculated in advance on the basis of the correlation graph without using the memory table and the target position according to the shift amount may be displayed on a monitor by the target position setting means.

When there is no optical axis shift of the laser beam for DVD obtained in this manner, in other words, in a case that Px=0(%) and Py=0(%) (NO in the step S8), there are no shifts of the optical axes of the laser beams for CD and DVD and thus the optical axis adjustment is completed (step S13). When the optical axis adjustments have been completed, the laser light source 52 and the light receiving element 70 are fixed to the frame 80 with an adhesive or the like.

On the other hand, when there is an optical axis shift of the laser beam for DVD, in other words, in a case that Px≠zero(%) and Py≠zero(%) (YES in the step S8), similarly to the optical axis adjusting device 1 in accordance with the first embodiment, the rotatable base 12 is turned around the center point C of the light receiving part 721 for CD on the basis of the real shift amount of the optical axis by using the memory table to adjust the optical axis of the laser beam for DVD (step S9).

After that, the laser beam for DVD is turned off (step S10) and then, if necessary, the laser beam for CD is outputted again (step S11) and a confirmation work whether there is an optical axis shift of the laser beam for CD or not (step S12).

In this step, when there is no optical axis shift of the laser beam for CD (NO in the step S12), the optical axis adjustment is completed (step S13). On the other hand, when an optical axis shift of the laser beam for CD has occurred again (YES in the step S12), the process is returned to the step S3 and the optical axis adjustments of the laser beams for CD and DVD are performed again. This confirmation work is performed to check again whether or not the optical axis shift occurs in the laser beam for CD which has been already adjusted and thus optical axis adjustment may be finished without performing the steps S11 and S12 after the optical axis of the laser beam for DVD has been adjusted (step S9).

In the embodiment described above, the optical axis adjusting device 2 is mounted with a pseudo disk for CD and the optical axis shift of the laser beam for DVD is calculated on the basis of the memory table through the shift amount of the optical axis in the non-corresponding state. However, on the contrary, the optical axis adjusting device 2 may be mounted with a pseudo disk for DVD and the optical axis shift of the laser beam for CD is calculated on the basis of a memory table.

Further, in the optical axis adjusting devices 1 and 2, the optical axis adjustment is performed by tuning the frame 80 to which the two-wavelength laser light source 52 is fixed. However, the present invention is not limited to this structure. For example, either an optical element structuring the optical system K or the light receiving element 70 may be turned to adjust the spot position SP1 or the spot position SP2 of the return light beam LR on the light receiving face 72 in the rotating direction.

As described above, according to the optical axis adjusting device 1(2) in accordance with the embodiment, either one of the two-wavelength laser light source 52, the light receiving element 70 and an optical element structuring the optical system K which structure the optical head device 50 is turned by the rotatable part 10 and, as a result, the spot position of the return light beam on the light receiving face 72 can be turned. Therefore, even when the optical head device 50 whose optical axes are to be adjusted is mounted with the two-wavelength laser light source 52, the optical axis adjustment can be rapidly performed and the return light beam LR comprising two kinds of the laser beams can be accurately coincided with the light receiving part 721 for CD or the light receiving part 722 for DVD of the light receiving element 70 and thus quality of the optical head device 50 is improved.

Further, the rotatable part 10 is capable of turning the entire frame 80 to which the two-wavelength laser light source 52 is fixed. Therefore, the optical axis adjustment for the optical head device 50 can be rapidly performed and the structure of the optical axis adjusting device 1(2) can be simplified.

Further, the optical axis adjusting device 2 in accordance with the embodiment is mounted with a pseudo disk for CD or a pseudo disk for DVD and is provided with a correcting means such as a memory table for converting the shift amount of the optical axis when a laser beam different from a laser beam for reproducing the mounted disk is emitted (shift amount of the optical axis in the non-corresponding state) into the shift amount of the optical axis when the laser beam is emitted to a corresponding disk (real shift amount of optical axis). Therefore, both the optical axis adjustments of the laser beams for CD and DVD can be performed by using a single optical axis adjusting device 2 on which either a pseudo disk for CD or a pseudo disk for DVD is mounted. Accordingly, the optical head device 50 is not required to replace from one optical axis adjusting device to another optical axis adjusting device like a case where both the optical axis adjusting device for CD and the optical axis adjusting device for DVD are used and thus the optical axis adjustment can be rapidly performed.

Further, in the optical axis adjusting method with the use of the optical axis adjusting device 1(2), the spot position of the return light beam LR of either of the laser beam for CD or the laser beam for DVD is adjusted so as to coincide with the light receiving part of the light receiving element 70 corresponding to the return light beam LR, and then the other return light beam is rotated or turned on the light receiving face 72 with the optical axis of the return light beam LR which has been already adjusted as the center and adjusted so that the spot position of the return light beam LR is coincided with the corresponding light receiving part. According to the optical axis adjusting method as described above, the optical axis adjustment can be rapidly and accurately performed and a manufacturing cost for the optical head device can be remarkably reduced and its quality can be improved.

Although the present invention has been shown and described with reference to specific embodiments, various changes and modifications will be apparent to those skilled in the art from the teachings herein

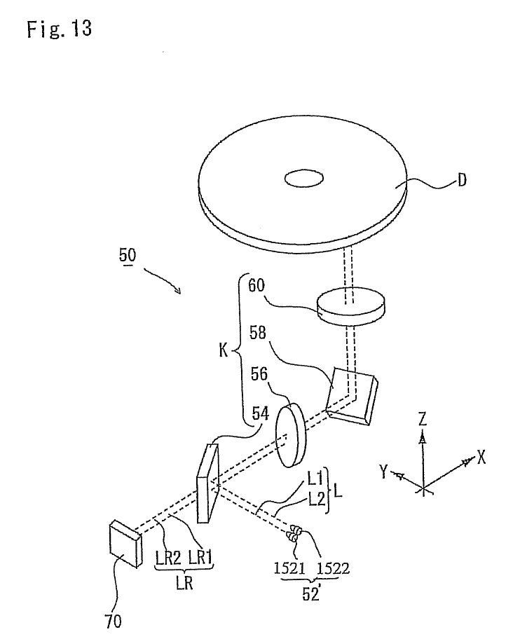

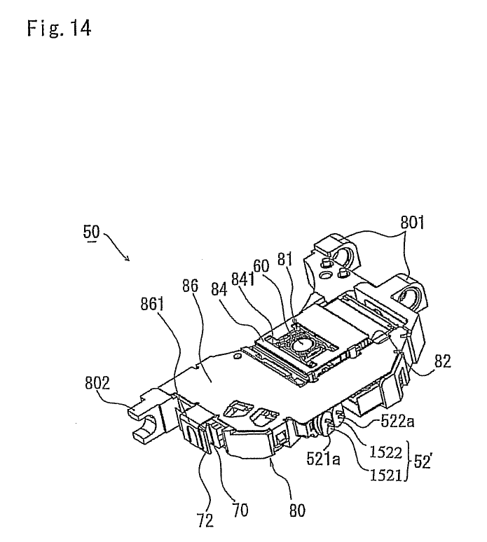

For example, as shown in FIGS. 13 and 14, the laser light source 52 which is a light source maybe changed into a laser light source 52′ which is comprised of a laser light source 1521 for CD and a laser light source 1522 for DVD. A light beam L1 with a red light area (bandwidth of about 650 nm) corresponding to a CD is emitted from a laser light source 1521 for CD and a light beam L2 with a near infrared light area (bandwidth of about 780 nm) corresponding to a DVD is emitted from a laser light source 1522 for DVD. The laser light source 52′ may be fixed to a side face of the frame 80 so that connection terminal parts 521a and 522a are directed to the outside

In this case, a pseudo disk for CD is mounted on the optical axis adjusting device 2 for adjusting the optical axes in the optical head device 50 as described above. In order to enable adjustment of the optical axes for a CD and a DVD only by using the optical axis adjusting device 2, the optical axis adjusting device 2 in accordance with this embodiment includes a memory table and a signal amplification means as a correcting means whose structure is similar to the above-mentioned embodiment. However, in this embodiment, when there is an optical axis shift of the laser beam for DVD, in other words, in a case that Px≠zero(%) and Py≠zero(%) (YES in the step S8), the rotatable base 12 maybe turned around the center point C of the light receiving part 721 for CD, or the light receiving element holding part 24 is moved in the X-axis direction and/or the Y-axis direction on the basis of the real shift amount of the optical axis by using the memory table to adjust the optical axis of the laser beam for DVD.

According to the optical axis adjusting device in accordance with this embodiment, only one of a pseudo disk for CD or a pseudo disk for DVD is mounted on the optical axis adjusting device and the optical axis adjusting device is provided with a memory table for converting the shift amount of the optical axis when a non-corresponding laser beam is irradiated on the pseudo disk (shift amount of the optical axis in the non-corresponding state) into the shift amount of the optical axis when the laser beam is irradiated on the corresponding disk (real shift amount of optical axis). Therefore, both the optical axis adjustments of the laser beams for CD and DVD can be performed by using a single optical axis adjusting device on which either a pseudo disk for CD or a pseudo disk for DVD is mounted.

Further, the memory table stores a difference between the shift amount of the optical axis in the non-corresponding state and the real shift amount of the optical axis and thus a signal amplifying circuit for converting the shift amount of the optical axis in the non-corresponding state into the real shift amount of the optical axis can be remarkably simplified.

The optical axis adjusting device in accordance with the embodiment described above can be utilized in an optical head device corresponding to both reproduction and recording of a CD and a DVD, in other words, in a so-called CD/DVD dual writer drive. However, the disk which is applicable to the present invention is not limited to a CD or a DVD.

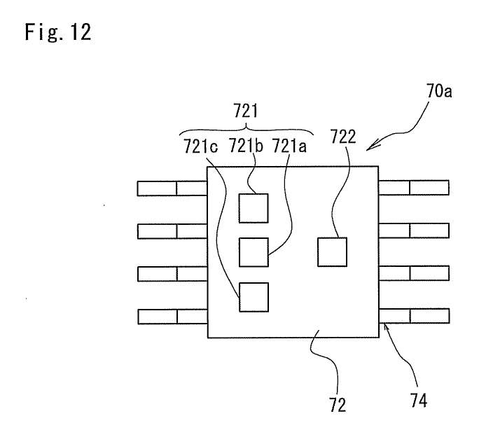

Further, at least an embodiment of the present invention may be applicable to an optical head device to which a so-called “three beam method” is adopted for enhancing stability of tracking for at least one of CD and DVD. For example, as shown in FIG. 12, even in an optical head device on which a light receiving element 70a is mounted that is provided with a light receiving part 721 for CD is comprised of a main light receiving part 721 a for receiving a main beam and two sub-light receiving parts 721b and 721c, the optical axis adjusting device and the optical axis adjusting method in accordance with at least an embodiment of present invention may be applied to the optical head device without sub-beams and, in this case, the optical axis adjustment of the sub-beams can be simultaneously completed with the optical axis adjustment of the main beam.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. An optical axis adjusting device for adjusting an optical axis in an optical head device comprising:
the optical head device comprising:
a two-wavelength laser light source which is capable of emitting two laser beams with two different wavelengths from each other;
a light receiving element which is provided with a light receiving face that is formed with two light receiving parts for respectively receiving return light beams from an optical recording medium of emitted light beams emitted from the two-wavelength laser light source; and
an optical system which forms an optical path of the emitted light beams and the return light beams; and
a rotatable part which is capable of turning one of the two-wavelength laser light source, the light receiving element and an optical element structuring the optical system for turning a spot position of the return light beam on the light receiving face.

2. The optical axis adjusting device according to claim 1, wherein the rotatable part turns one of a frame structuring the optical head device to which the two-wavelength laser light source is fixed and the light receiving element.

3. The optical axis adjusting device according to claim 1, wherein
the rotatable part is turnably mounted on a main base so that the optical head device to which the two-wavelength laser light source and the optical element structuring the optical system are fixed is capable of being turned, and
an axis X which is a turning center of the rotatable part is set to be at a spot position of one of the return light beams of the two laser beams.

4. The optical axis adjusting device according to claim 3, wherein the main base is mounted with a mounting position adjustment part for adjusting a mounting position of the light receiving element in the optical head device.

5. The optical axis adjusting device according to claim 1, further comprising:
one of two kinds of optical media which are respectively to be reproduced by the laser beams with two different wavelengths; and
a correcting means for converting an optical axis shift on the light receiving face when an other laser beam which is different from a laser beam for reproducing the one of two kinds of optical media is emitted to the one of two kinds of optical media, into an optical axis shift on the light receiving face when the other laser beam is emitted to the other of two kinds of optical media.

6. The optical axis adjusting device according to claim 5, further comprising a memory table which is included in the correcting means,
wherein the memory table includes correction data on a basis of difference between the optical axis shift on the light receiving face when the other laser beam is emitted to the one of two kinds of optical media and the optical axis shift on the light receiving face when the other laser beam is emitted to the other of two kinds of optical media.

7. The optical axis adjusting device according to claim 5, wherein the correcting means comprises:
a monitor which is capable of taking a position of the return light beam on the light receiving face; and
a target position setting means for displaying a target position of an optical axis of the other laser beam on the light receiving face on the monitor on a basis of correlation between the optical axis shift on the light receiving face when the other laser beam is emitted to the one of two kinds of optical media and the optical axis shift on the light receiving face when the one of the laser beams is emitted to the one of two kinds of optical media.

8. The optical axis adjusting device according to claim 5, wherein
the correcting means includes correlation data between an optical axis shift of a return light beam on the light receiving face when the other laser beam is irradiated on a pseudo disk for optical axis adjustment corresponding to the one of the laser beams and an optical axis shift of a return light beam on the light receiving face when the other laser beam is irradiated on a pseudo disk for optical axis adjustment corresponding to the other laser beam, and
a position on the light receiving face when the other laser beam is emitted is adjusted on a basis of the optical axis shift which is obtained by irradiating the other laser beam on the pseudo disk for optical axis adjustment corresponding to the one of the laser beams.

9. The optical axis adjusting device according to claim 8, wherein
the rotatable part is turnably mounted on a main base so that the optical head device to which the two-wavelength laser light source and the optical element structuring the optical system are fixed is capable of being turned, and
the main base is mounted with a mounting position adjustment part for adjusting a mounting position of the light receiving element in the optical head device.

10. The optical axis adjusting device according to claim 9, wherein an axis X which is a turning center of the rotatable part is set to be at a spot position of one of the return light beams of the two laser beams.

11. An optical axis adjusting device for adjusting an optical axis in an optical head device comprising:
the optical head device comprising:
two light sources which are capable of emitting respective laser beams with different wavelengths from each other;
a light receiving element which is provided with a light receiving face that is formed with two light receiving parts for respectively receiving return light beams from an optical recording medium of emitted light beams emitted from the light sources; and
an optical system which forms an optical path of the emitted light beams and the return light beams; and
one of two kinds of optical media which are respectively to be reproduced by the laser beams with two different wavelengths; and
a correcting means for converting an optical axis shift on the light receiving face when an other laser beam which is different from a laser beam for reproducing the one of the optical media is emitted to the one of the optical media, into an optical axis shift on the light receiving face to the other of the optical media.

12. The optical axis adjusting device according to claim 11, further comprising a memory table which is included in the correcting means,
wherein the memory table includes correction data on a basis of difference between the optical axis shift on the light receiving face when the other laser beam is emitted to the one of the optical media and the optical axis shift on the light receiving face when the other laser beam is emitted to the other of the optical media.

13. The optical axis adjusting device according to claim 11, wherein the correcting means comprises:
a monitor which is capable of taking a position of the return light beam on the light receiving face; and
a target position setting means for displaying a target position of an optical axis of the other laser beam on the light receiving face on the monitor on a basis of correlation between the optical axis shift on the light receiving face when the other laser beam is emitted to the one of the optical media and the optical axis shift on the light receiving face when the one of the laser beams is emitted to the one of the optical media.

14. The optical axis adjusting device according to claim 11, wherein two kinds of optical media are a CD and a DVD.

15. An optical axis adjusting method in an optical axis adjusting device for adjusting optical axes in an optical head device which is provided with a two-wavelength laser light source which is capable of emitting two laser beams with two different wavelengths from each other, a light receiving element which is provided with a light receiving face that is formed with two light receiving parts for respectively receiving return light beams from an optical recording medium of emitted light beams emitted from the two-wavelength laser light source, and an optical system which forms an optical path of the emitted light beams and the return light beams, comprising:
previously providing a rotatable part which is capable of turning one of the two-wavelength laser light source, the light receiving element and an optical element structuring the optical system for turning a spot position of the return light beam on the light receiving face;
a first adjusting step in which a spot position of one of the return light beams is adjusted so as to coincide with a light receiving part corresponding to the one of the return light beams; and
a second adjusting step in which the rotatable part is turned with an optical axis of the return light beam which has been adjusted in the first adjusting step as a turning center so that a spot position of the other of the return light beams is adjusted so as to coincide with a light receiving part corresponding to the other of the return light beams.
